(19) United States
(12) Patent Application Publication
(10) Pub. No.: US 2025/0378973 A1
(43) Pub. Date: Dec. 11, 2025

(54) DATA LINE AND MANUFACTURING METHOD THEREOF

(71) Applicant: Anker Innovations Technology Co., Ltd., Changsha (CN)

(72) Inventors: Xiaoshu Zhang, Shenzhen (CN); Chuanwu Zhang, Shenzhen (CN); Hongzhi Yan, Shenzhen (CN)

(21) Appl. No.: 19/231,829

(22) Filed: Jun. 9, 2025

(30) Foreign Application Priority Data
Jun. 7, 2024 (CN) 202410741350.7

(51) Int. Cl. H01B 7/02; H01B 11/18; H01B 13/06

(52) U.S. Cl. CPC H01B 7/02; H01B 11/1895; H01B 13/06

(57) ABSTRACT

Disclosed are a data line and a manufacturing method thereof. The data line includes a terminal assembly, a core wire assembly, a braided layer, and a filling layer. The terminal assembly is coupled to an electronic device. The core wire assembly is coupled to the terminal assembly and is configured to conduct electricity. The braided layer has a plurality of braiding gaps, and the filling layer is filled in the plurality of braiding gaps, the filling layer and the braided layer jointly enclosing the core wire assembly. The filling layer is provided in the braiding gaps of the braided layer and can be completely or partially filled in the braiding gaps, making it difficult for dust and stains to deposit in the braiding gaps, preventing the data line from accumulating dust and improving stain resistance of the data line.

### CROSS-REFERENCE TO RELATED APPLICATION

This application claims priority to CN application No. 202410741350.7, filed on Jun. 7, 2024. The entire content of the prior application is incorporated herein by reference.

### FIELD

The present disclosure relates to the technical field of electronics, in particular to a data line and a manufacturing method thereof.

### BACKGROUND

In modern electronic devices, data lines or cables are generally used for charging and data transmission. With the widespread adoption of mobile devices, the demand for data lines is also increasing. To enhance durability, a cable is typically covered with a braided layer, which is usually woven from multiple strands of filaments, providing additional protection and improving the strength, flexibility and appearance of the data line. However, the braided data line tends to accumulate dust and is prone to staining. Since the data line cannot be washed with water, this can affect its performance and negatively impact the user experience.

### SUMMARY

Examples of the disclosure provide a data line which can prevent the data line from accumulating dust and improve stain resistance. In a first aspect, an example of the disclosure provides a data line including a terminal assembly, a core wire assembly, a braided layer, and a filling layer. The terminal assembly is configured to be connected with or coupled to an electronic device. The core wire assembly is connected with or coupled to the terminal assembly and is configured to conduct electricity. The braided layer has a plurality of braiding gaps, and the filling layer is filled in the plurality of braiding gaps and jointly encloses the core wire assembly with the braided layer.

In a second aspect, an example of the disclosure further provides a manufacturing method of a data line including a core wire assembly and a braided layer which encloses the core wire assembly. The manufacturing method includes: attaching a filling coating to the braided layer; and baking the data line attached with the filling coating.

Based on the data line in the example of the disclosure, the filling layer is provided in the braiding gaps of the braided layer and can be completely or partially filled in the braiding gaps, thereby making it difficult for dust and stains to deposit in the braiding gaps, preventing the data line from accumulating dust and improving stain resistance of the data line.

### BRIEF DESCRIPTION OF THE DRAWINGS

In order to more clearly illustrate technical solutions in examples of the present disclosure or in the related art, drawings that need to be used in description of the examples or the related art are briefly introduced below, and it will be apparent to those of ordinary skill in the art that the drawings in the following description are merely some examples of the disclosure, and other drawings may be obtained in accordance with structures shown in these drawings without inventive work.

FIG. 1 is a perspective view of a data line of the present disclosure;

FIG. 2 is a cross-sectional view of a core wire assembly in FIG. 1;

FIG. 3 is a cross-sectional view of the data line in FIG. 1;

FIG. 4 is an enlarged view of part A in FIG. 3;

FIG. 5 is a perspective view of an inner mold of the present disclosure;

FIG. 6 is a perspective view of an outer shell of the present disclosure;

FIG. 7 is a perspective view of the outer shell of the present disclosure from another perspective; and

FIG. 8 is a flowchart of an example of a manufacturing method of the present disclosure.

### DESCRIPTION OF REFERENCE NUMERALS

100. Data Line; 1. Terminal Assembly; 11. Connecting Terminal; 12. Outer Shell; 121. Accommodation Cavity; 122. Second Surface; 1221. Second Opening; 123. Third surface; 124. Fourth Surface; 125. First Surface; 1251. First Opening; 126. Annular Groove; 13. Inner Module or Mold; 131. Rib; 132. Overflow Groove; 1321. First Groove; 1322. Second Groove; 133. Bump or Protrusion; 2. Core Wire Assembly; 21. Insulating Layer; 22. Shielding Layer; 23. Core Wire; 24. Nylon Yarn; 3. Braided Layer; 31. Braiding gap; 4. Filling Layer.

Achievement of the object, functional features and advantages of the disclosure will be further described in combination with examples and with reference to the accompanying drawings.

### DETAILED DESCRIPTION

In order to make understanding of the object, technical solutions and advantages of the present disclosure clearer, the present disclosure will be described in further detail below with reference to the accompanying drawings. It should be understood that the specific examples described herein are only used to explain the disclosure and are not used to limit the disclosure.

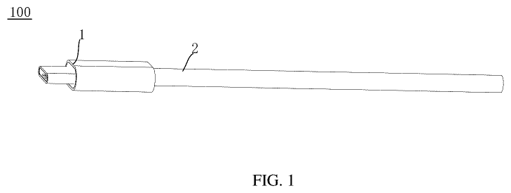

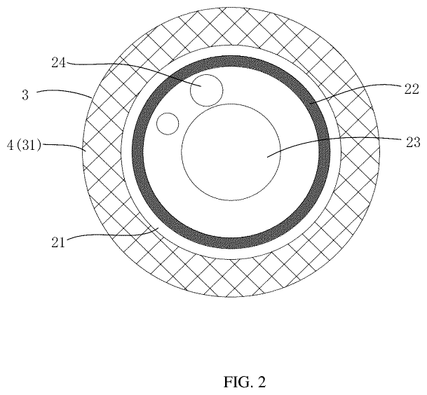

Referring to FIGS. 1 and 2, a data line 100 is proposed in a first aspect of examples of the present disclosure, which includes a terminal assembly 1, a core wire assembly 2, a braided layer 3, and a filling layer 4.

The terminal assembly 1 is configured to be connected with or coupled to an electronic device. For example, the terminal assembly 1 is configured to be connected with a mobile phone, a tablet computer, a notebook, a desktop, a charger, or the like. The type of the terminal assembly 1 may be USB-A or USB-C, for example.

The core wire assembly 2 is connected with or coupled to the terminal assembly 1 and is configured to conduct electricity, which includes charging an electronic device, transmitting data to the electronic device, or transmitting data while charging. Generally speaking, both ends of the core wire assembly 2 are respectively provided with terminal assemblies 1, and types of the two terminal assemblies can be the same or different.

The braided layer 3 covers an outer surface of the core wire assembly 2, and the braided layer 3 can be made of nylon or the like. When a user pulls the data line 100, the braided layer 3 can bear part of a pulling force, thus protecting the core wire assembly 2. The braided layer 3 can not only enhance durability of the data line 100, but also improve the appearance of the data line 100. The braided layer 3 can be of a net structure woven by nylon wires, thus improving toughness and wear resistance of the data line 100.

It can be understood that since the braided layer 3 is a fabric, the braided layer 3 has a plurality of braiding gaps 31, which include gaps between single-strand threads. It can also be understood that the plurality of the braiding gaps 31 also include gaps inside a single strand of thread, because the single strand of thread may be woven from multiple strands of thinner threads and there are gaps between a plurality of the thinner threads. The filling layer 4 is filled in the plurality of braiding gaps 31, so as to be closely integrated with the braided layer 3. For example, the filling layer 4 is made of a flexible and skin-friendly material, which makes the data line 100 relatively soft, provides a better hand feel, and offers improved bending resistance, reducing the likelihood of damage during bending.

In the example provided in the disclosure, the filling layer 4 is provided in a plurality of the braiding gaps 31 and can be completely or partially filled in the braiding gaps 31, making it difficult for dust and stains to deposit in the braiding gaps 31. The filling layer 4 and the braided layer 3 jointly cover or enclose the core wire assembly 2, which can prevent dust and stains from entering the braided layers or being adsorbed in the braided layer 3 and prevent the data line 100 from accumulating dust, thereby improving stain resistance of the data line 100.

Meanwhile, because the braided layer 3 is a fabric, for example, the braided layer 3 is generally made of polyester, nylon or cotton thread, the braided layer 3 is prone to pilling. The filling layer 4 of this example is closely integrated with the braided layer 3, and the filling layer 4 can also protect the braided layer 3 to avoid pilling of the braided layer 3. In addition, the filling layer 4 can also improve tensile strength and waterproof performance of the data line 100.

In some examples of the disclosure, the filling layer 4 comprises one or more of methyvinylsiloxane, silicon dioxide, hydrosilicone oil and light white oil in parts by mass. For example, the filling layer 4 contains 25 to 35 parts by mass of methyvinylsiloxane, 10 to 20 parts by mass of silicon dioxide, 10 to 20 parts by mass of hydrosilicone oil, and 35 to 45 parts by mass of light white oil. For example, the filling layer 4 contains 25 parts by mass of methyvinylsiloxane, 20 parts by mass of silicon dioxide, 20 parts by mass of hydrosilicone oil and 35 parts by mass of light white oil. Alternatively, the filling layer 4 contains 35 parts by mass of methyvinylsiloxane, 10 parts by mass of silicon dioxide, 10 parts by mass of hydrosilicone oil and 45 parts by mass of light white oil. Alternatively, the filling layer 4 contains 30 parts by mass of methyvinylsiloxane, 15 parts by mass of silicon dioxide, 15 parts by mass of hydrosilicone oil and 40 parts by mass of light white oil.

The hydrosilicone oil is a type of organic silicone oil, which has good lubricity and excellent hydrophobicity, and can form a waterproof layer to prevent moisture from entering the braiding gap 31 and avoid interference with the core wire assembly 2. The methyvinylsiloxane not only has good lubricity and waterproof performance, but also has adhesion, which can firmly connect the filling layer 4 to the braided layer 3. Furthermore, the methyvinylsiloxane also has excellent sealing performance and avoids a gap between the filling layer 4 and the braided layer 3 that dust can enter, which can make the data line 100 more dust-resistant. The methyvinylsiloxane, hydrosilicone oil and light white oil all have lubricity, which can not only improve the dirt resistance of the data line 100, but also avoid a rough surface of the data line 100, thus avoiding pilling of the data line 100.

In some examples, the filling layer 4 may further contain 5 to 10 parts by mass of silicate paint. For example, the filling layer 4 contains 25 parts by mass of methyvinylsiloxane, 20 parts by mass of silicon dioxide, 15 parts by mass of hydrosilicone oil, 35 parts by mass of light white oil and 5 parts by mass of silicate paint. Alternatively, the filling layer 4 contains 30 parts by mass of methyvinylsiloxane, 10 parts by mass of silicon dioxide, 10 parts by mass of hydrosilicone oil, 40 parts by mass of light white oil and 10 parts by mass of silicate paint. Alternatively, the filling layer 4 contains 30 parts by mass of methyvinylsiloxane, 11 parts by mass of silicon dioxide, 14 parts by mass of hydrosilicone oil, 37 parts by mass of light white oil and 8 parts by mass of silicate paint. The silicate paint has characteristics of smooth feel and a matt surface and has excellent skin-friendly characteristics, which can further improve user feel of the data line 100. Moreover, the silicate paint also has anti-allergic effect and is more user friendly.

It should be noted that the dirt resistance of the data line 100 is achieved by filling the filling layer 4 with a hydrophobic function in the braiding gap 31 of the braided layer 3, and thus the filling layer 4 contains, but is not limited to, the above formulation. In some examples, the filling layer 4 can also contain other nano-coatings with a hydrophobic function, and the dirt resistant function can also be achieved by dipping the coatings into the gap of the braided layer and curing the coatings.

In some examples of the present disclosure, the core wire assembly 2 includes a core wire 23, a shielding layer 22 and an insulating layer 21. The core wire 23 can be configured to conduct electricity. The core wire 23 includes a plurality of thin wires, for example, and the number of the thin wires can vary with the type of the terminal assembly 1.

The shielding layer 22 covers the core wire 23, and can prevent external electromagnetic interference from affecting a signal transmitted by the core wire 23. The electromagnetic interference may come from other electronic devices, power cords or other wireless signal sources, and may interfere with weak signals transmitted in the data line 100, resulting in errors in data transmission or performance degradation of the data line 100. The shielding layer 22 provides a conductive barrier to effectively guide the interference signal to the ground, thus protecting the signal transmitted by the inner core wire 23 from being affected. Moreover, the shielding layer 22 can also reduce outward radiation of the signal.

The shielding layer 22 can be made of graphene, and can provide effective electromagnetic shielding in a wide frequency range, with good shielding effect from a low frequency to a high frequency. The graphene can also be combined with other materials to make the flexible shielding layer 22, so as to improve flexibility of the data line 100. The graphene can be made into a thin single-layer or less-layer structure, which facilitates reducing weight and volume of the core wire assembly 2 of the data line 100 while maintaining electromagnetic shielding effect. The shielding layer 22 can also cover multiple strands of nylon yarns 24, which can improve overall toughness of the data line 100.

The insulating layer 21 covers the shielding layer 22, and the insulating layer 21 can function in insulation to avoid electric leakage of the core wire 23. The insulating layer 21 is wrapped outside the shielding layer 22, which can protect the data line 100 from external environment (such as moisture and dirt) and can fix the core wire 23 in place. The insulating layer 21 can also provide certain physical protection to prevent the core wire 23 and the shielding layer 22 from being mechanically damaged. The insulating layer 21 can contain one or more of silica gel, thermoplastic elastomer, Teflon, Hytrel, modified polypropylene and the like. The silica gel, thermoplastic elastomer, Teflon, Hytrel and modified polypropylene are all high temperature resistant materials, which can enable the data line 100 to withstand a high-temperature environment. It should be noted that coating of the filling layer 4 may need a baking process, and thus the insulating layer 21 of the example of the present disclosure is made of a high temperature resistant material, so that the insulating layer 21 can withstand a high temperature of the baking process when the filling layer 4 is applied.

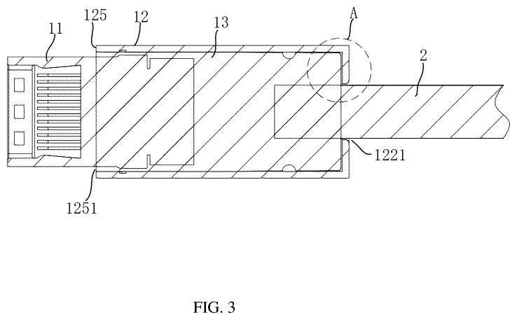

As shown in FIG. 3, in some examples of the present disclosure, the terminal assembly 1 includes a connecting terminal 11, an inner module 13 and an outer shell 12.

The connecting terminal 11 is connected with or couple to the core wire assembly 2, and the connecting terminal 11 has a plugging direction, which is a direction in which the connecting terminal 11 is plugged into the electronic device. The connecting terminal 11 may be a male or female connector.

The inner module or inner mold 13 covers (e.g., encapsulates) a connection between the connecting terminal 11 and the core wire assembly 2, and can be a plastic inner film. The inner module 13 is formed at the connection between the connecting terminal 11 and the core wire assembly 2 by injection molding, so that the inner module 13 has low cost and good insulation, and can ensure insulation effect at the connection between the core wire assembly 2 and the connecting terminal 11, thus avoiding potential safety hazards such as short circuit or electric shock. Moreover, the inner module 13 can seal the connection between the core wire assembly 2 and the connecting terminal 11, which on one hand can improve strength and waterproof effect of the connection between the connecting terminal 11 and the core wire assembly 2, and on the other hand can facilitate reducing electromagnetic interference and radio frequency interference, improving stability and accuracy of data transmission of the core wire assembly 2.

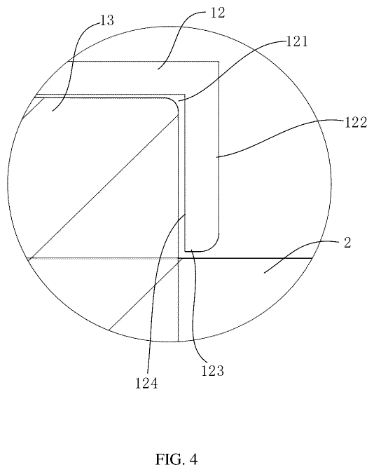

As shown in FIG. 4, the outer shell 12 has an accommodation cavity 121, and the inner module 13 is provided in the accommodation cavity 121, and the outer shell 12 can protect the inner module 13. The outer shell 12 can be made of aluminum alloy for example, so that the outer shell 12 has high strength, long service life and good heat dissipation performance. An outer wall of the outer shell 12 has a first surface 125 and a second surface 122 which are disposed opposite to each other in the plugging direction. The first surface 125 is provided with a first opening 1251 for the connecting terminal 11 to pass through, that is, the first opening 1251 communicates with the accommodation cavity 121, and the connecting terminal 11 can pass through the first opening 1251 to be connected with electronic device. The second surface 122 is provided with a second opening 1221 for the core wire assembly 2 to pass through, that is, the second opening 1221 is communicated with the accommodation cavity 121, and the core wire assembly 2 can pass through the second opening 1221 to be connected with the connecting terminal 11 at the other end. A surface of the second opening 1221 facing the core wire assembly 2 is a third surface 123, and a cross-section of a joint or junction between the third surface 123 and the second surface 122 is a curved surface. In contrast with conventional design where the joint between the third surface 123 and the second surface 122 forms a sharp ridge, the sharp edges of the outer shell 12 may cut into the data line 100, causing damage. In the example of the present disclosure, the cross-section of the joint between the third surface 123 and the second surface 122 is of the curved surface, with a larger contact area between the curved surface and the core wire assembly 2 and a small pressure of the outer shell 12 on the core wire assembly 2, thereby reducing local wear of the outer shell 12 on the core wire assembly 2 and preventing the data line 100 from being cut by the outer shell 12.

It should also be noted that in order to solve a problem of connection fragility between the core wire assembly 2 and the outer shell 12, a stress relief sleeve made of a rigid material is generally sleeved at an end of the core wire assembly 2.

On one hand, the data line 100 of the present disclosure is provided with the braided layer 3 and the filling layer 4, which can improve strength of the core wire assembly 2 and make the core wire assembly 2 less prone to damage; and on the other hand, the joint or junction between the third surface 123 and the second surface 122 is provided with the curved surface, thereby reducing stress concentration. Thus, service life of the data line 100 can be ensured without providing the stress relief sleeve, resulting in a simpler structure of the data line.

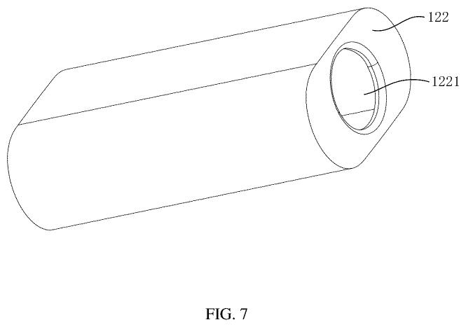

As shown in FIGS. 4 and 7, in some examples, the cross-section of the joint between the third surface 123 and the second surface 122 is a curved surface, which facilitates manufacturing process The curved surface can also provide more avoidance space for the core wire assembly 2. When the core wire assembly 2 is bent, the contact area between the core wire assembly 2 and the outer shell 12 is small, thus avoiding the core wire assembly 2 from being damaged and prolonging the service life of the data line 100. When the core wire assembly 2 is bent, the curved surface can define a bending amplitude of the core wire assembly 2, so that the bending amplitude of the core wire assembly 2 is uniform, preventing the core wire assembly 2 from being damaged. A radius corresponding to the curved surface is greater than or equal to 0.15 mm and less than or equal to 0.5 mm. For example, the radius corresponding to the curved surface can be 0.15 mm, 0.2 mm or 0.3 mm. If the radius corresponding to the curved surface is too large, the bending amplitude of the core wire assembly 2 is small, and the core wire assembly 2 is prone to friction with the outer shell 12. If the radius corresponding to the curved surface is too small, the bending amplitude of the core wire assembly 2 is too large, and the core wire assembly 2 is prone to damage.

In some examples, the third surface 123 abuts against or in contact with the core wire assembly 2, providing greater stability to the core wire assembly 2. When the core wire assembly 2 subjects to movement or vibration, impact between the core wire assembly 2 and the third surface 123 is reduced, and thus the core wire assembly 2 is less prone to damage. For example, a diameter of the core wire assembly 2 is the same as that of the second opening 1221, or the diameter of the core wire assembly 2 is slightly larger than that of the second opening 1221, so as to ensure greater stability to the core wire assembly 2 and avoid the core wire assembly 2 from being excessively squeezed.

As shown in FIG. 4, in some examples, an inner wall of the accommodation cavity 121 has a fourth surface 124 connected with the third surface 123, and the fourth surface 124 is disposed perpendicular to the third surface 123, that is, a joint or junction between the fourth surface 124 and the third surface 123 has a sharp ridge, which facilitates improved fit between the inner module 13 and the fourth surface 124, thereby improving sealing effect between the outer shell 12 and the inner module 13, preventing dust from entering the accommodation cavity 121, and making it less prone to harbor dirt in the accommodation cavity 121. In addition, the fourth surface 124 is disposed perpendicular to the third surface 123, which enables the outer shell 12 to limit the inner module 13, so that the inner module 13 can be located in the accommodation cavity 121 more firmly.

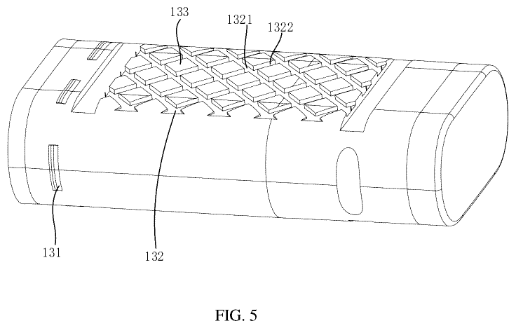

As shown in FIG. 5, in some examples of the present disclosure, the inner module 13 and the outer shell 12 are connected by an adhesive, which may include glue. In order to connect or bond the outer shell 12 and the inner module 13 more stably, an outer surface of the inner module 13 is provided with an overflow groove 132 configured to accommodate the adhesive.

During assembly of the inner module 13 and the outer shell 12, the adhesive can be applied to the overflow groove 132 and an inner surface of the outer shell 12, and then the inner module 13 can be inserted into the accommodation cavity 121 of the outer shell 12, enabling the adhesive to securely bond the outer shell 12 to the inner module 13. The overflow groove 132 is provided to accommodate a large amount of adhesive, thereby ensuring sufficient contact between the adhesive and the inner surface of the outer shell 12 as well as the outer surface of the inner module 13. After the adhesive is cured, it not only bonds to the inner module 13, but also mechanically engages with the overflow groove 132, thus enhancing connection strength between the adhesive and the inner module 13.

The overflow groove 132 includes a first groove 1321 extending along a first direction and a second groove 1322 extending along a second direction, the first direction and the second direction intersect, and the first groove 1321 and the second groove 1322 are staggered. The staggered arrangement of the first groove 1321 and second groove 1322 enables the applied forces to be dispersed in multiple directions and over a larger area, thus improving adhesion the stability of the adhesion between the outer shell 12 and the inner module 13.

In some examples of the present disclosure, the first groove 1321 and the second groove 1322 enclose a bump or protrusion 133, and a plurality of bumps or protrusions 133 may be formed. That is, there are a plurality of first grooves 1321 which are uniformly spaced; there are a plurality of second grooves 1322 which are uniformly spaced, and a plurality of the first grooves 1321 and a plurality of the second grooves 1322 enclose a plurality of the bumps 133. The shape of the bump 133 is substantially cubic, and the bump 133 has four surfaces intersecting the plugging direction. When the data line 300 is used, a direction of a pulling force applied to the inner module 13 is often the same as the plugging direction. When the inner module 13 is pulled by an external force, four surfaces of the bump 133 share the pulling force together, thus improving pulling resistance of the inner module 13 and preventing the inner module 13 from being deformed or damaged by pulling.

In some examples, an included angle between the first direction and the plugging direction is the same as an included angle between the second direction and the plugging direction. Alternatively, the included angle between the first direction and the plugging direction can be 45 degrees, and the included angle between the second direction and the plugging direction can also be 45 degrees. The four surfaces of the bump 133 can be uniformly stressed, which avoids an excessive localized stress on the bump 133, and thus can further improve the pulling resistance of the inner module 13.

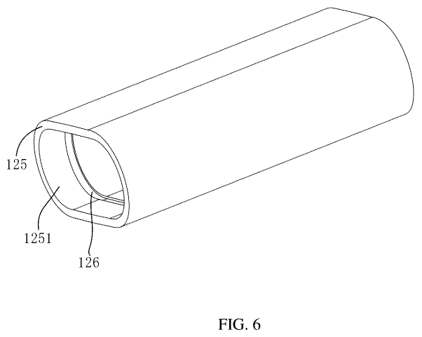

As shown in FIG. 6, in some examples of the present disclosure, the inner wall of the outer shell 12 is provided with an annular groove 126 surrounding the plugging direction, and a surface of the inner module 13 facing the outer shell 12 is provided with a rib 131, the rib 131 is inserted into the annular groove 126 to fit the annular groove 126 in a limiting manner (e.g., in a limiting fit), so as to limit the rib 131 from moving relative to the outer shell 12 in the plugging direction to a certain extent, thereby improving the pulling resistance of the data line. The rib 131 may be disposed around the inner module 13. A plurality of ribs 131 may be possible, and the plurality of the ribs 131 are arranged at intervals along a circumferential direction of the inner module 13. The annular groove 126 can be the same as the outer shell 12 in shape. When the outer shell 12 is racetrack-shaped, the annular groove 126 can also be racetrack-shaped, which can prevent the inner module 13 from rotating around the plugging direction.

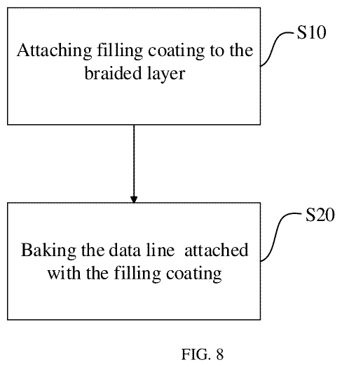

In a second aspect, referring to FIG. 8, a manufacturing method of a data line 100 is further provided in an example of the disclosure. The data line includes a core wire assembly 2 and a braided layer 3, and the braided layer 3 covers or encloses an outer surface of the core wire assembly 2.

The method includes following steps S10 and S20. Step S10: a filling coating is attached to the braided layer 3. The filling coating can be attached to the braided layer 3 in various ways, such as by soaking the braided layer 3 in the filling coating, or spraying the filling coating on the braided layer 3, or brushing the filling coating on the braided layer 3.

Step S20: the data line 100 attached with the filling coating is baked. Baking can shorten curing time of the filling coating and improve production efficiency. It should be noted that different coatings have different curing methods. Some coatings selected in the example of this disclosure need a baking process, while some other coatings may not need the baking process.

In order to fully fill the braided layer 3 with the filling coating, the filling coating can be accommodated in an immersion tank first, then the data line 100 is completely immersed in the immersion tank, and the filling coating in the immersion tank may penetrate into the braided layer 3. After soaking for a period of time, the data line 100 is taken out, and finally the soaked data line 100 is baked. After heating, the filling coating may cure and fill inside the braided layer 3 and form the filling layer 4, so as to prevent dust from entering the braided layer 3 and enhance anti-pollution ability of the data line 100.

It should be noted that in a process of manufacturing the data line 100, the braided layer 3 can be braided on the core wire assembly 2 first, then the filling coating is attached to the braided layer 3, and finally the core wire assembly 2 and the terminal assembly 1 are welded and assembled with each other. Thus, when the filling coating is attached to the braided layer 3, the data line 100 temporarily does not include the terminal assembly 1. Alternatively, in a process of manufacturing the data line 100, the core wire assembly 2 and the terminal assembly 1 can be welded and assembled first, then the braided layer 3 is braided on the core wire assembly 2, and finally the filling coating is attached to the braided layer 3, so that when the filling coating is attached to the braided layer 3, the data line 100 includes the terminal assembly 1.

In some examples, the filling coating comprises one or more of methyvinylsiloxane, silicon dioxide, hydrosilicone oil and light white oil in parts by mass. For example, the filling coating contains 25 to 35 parts by mass of methyvinylsiloxane, 10 to 20 parts by mass of silicon dioxide, 10 to 20 parts by mass of hydrosilicone oil, and 35 to 45 parts by mass of light white oil. For example, the filling coating contains 25 parts by mass of methyvinylsiloxane, 20 parts by mass of silicon dioxide, 20 parts by mass of hydrosilicone oil and 35 parts by mass of light white oil. Alternatively, the filling coating contains 35 parts by mass of methyvinylsiloxane, 10 parts by mass of silicon dioxide, 10 parts by mass of hydrosilicone oil and 45 parts by mass of light white oil. Alternatively, the filling coating contains 30 parts by mass of methyvinylsiloxane, 15 parts by mass of silicon dioxide, 15 parts by mass of hydrosilicone oil and 40 parts by mass of light white oil.

In some examples, the filling coating may further contain 5 to 10 parts by mass of silicate paint. For example, the filling coating contains 25 parts by mass of methyvinylsiloxane, 20 parts by mass of silicon dioxide, 15 parts by mass of hydrosilicone oil, 35 parts by mass of light white oil, and 5 parts by mass of silicate paint. Alternatively, the filling coating contains 30 parts by mass of methyvinylsiloxane, 10 parts by mass of silicon dioxide, 10 parts by mass of hydrosilicone oil, 40 parts by mass of light white oil and 10 parts by mass of silicate paint. Alternatively, the filling coating contains 30 parts by mass of methyvinylsiloxane, 11 parts by mass of silicon dioxide, 14 parts by mass of hydrosilicone oil, 37 parts by mass of light white oil and 8 parts by mass of silicate paint. The silicate paint has characteristics of smooth feel and a matt surface and has excellent skin-friendly characteristics, which can further improve user feel of the data line 100. Moreover, the silicate paint also has anti-allergic effect and is more user-friendly.

In some examples, baking the data line 100 attached with the filling coating includes baking the soaked data line 100 at a preset temperature for 2 to 3 hours, so that the filling coating is cured. The preset temperature can be 180° C. to 220° C., such as 180° C., 200° C., and 220° C. The silicon dioxide has excellent high-temperature resistance, which can further improve the high-temperature resistance of the core wire assembly 2, and can also make the filling coating less volatile in an oven at 180° C. to 220° C. With baking by heating for 2 to 3 hours, the filling coating can be heated more fully, cured more fully, and thus filled in the braided layer 3 more firmly.

The same or similar reference numerals in the drawings of examples of the present disclosure correspond to the same or similar parts. In the description of the present disclosure, it is to be understood that the terms “upper”, “lower”, “left”, “right”, and the like indicating relationships of directions and positions are based on relationships of directions and positions shown in the drawings, and are intended to be illustrative and simplify descriptions only and not to indicate or imply that the referred device or element must be provided in a particular direction, configured and operated in a particular direction. Therefore, the terms used to describe relationships of positions are intended to be illustrative only and are not intended to limit the present disclosure. For those skilled in the art, specific meanings of the above terms can be understood according to specific situations.

The above are only examples of the present disclosure and are not intended to limit the disclosure. Any modifications, equivalent substitutions, improvements or the like within the spirit and principle of the disclosure should be included in the scope of the disclosure.

What is claimed is:

1. A data line comprising:
a terminal assembly coupled to an electronic device;
a core wire assembly coupled to the terminal assembly and configured to conduct electricity;
a braided layer having a plurality of braiding gaps; and
a filling layer filled in the plurality of braiding gaps, wherein the filling layer and the braided layer jointly enclose the core wire assembly.

2. The data line according to claim 1, wherein the filling layer comprises 25 to 35 parts by mass of methyvinylsiloxane, 10 to 20 parts by mass of silicon dioxide, 10 to 20 parts by mass of hydrosilicone oil, or 35 to 45 parts by mass of light white oil.

3. The data line according to claim 1, wherein the core wire assembly comprises:
a core wire;
a shielding layer enclosing the core wire; and
an insulating layer enclosing the shielding layer,
wherein the insulating layer comprises one or more of silica gel, thermoplastic elastomer, Teflon, Hytrel and modified polypropylene.

4. The data line according to claim 1, wherein the terminal assembly comprises:
a connecting terminal coupled to the core wire assembly, the connecting terminal having a plugging direction;
an inner mold encapsulating a connection between the connecting terminal and the core wire assembly; and
an outer shell having an accommodation cavity in which the inner mold is provided, wherein an outer wall of the outer shell has a first surface and a second surface which are disposed opposite in the plugging direction, the first surface is provided with a first opening for the connecting terminal to pass through, and the second surface is provided with a second opening for the core wire assembly to pass through.

5. The data line according to claim 4, wherein a surface of the second opening facing the core wire assembly is a third surface, and a cross-section of a joint between the third surface and the second surface is a curved surface.

6. The data line according to claim 5, wherein a radius corresponding to the curved surface is greater than or equal to 0.15 mm and less than or equal to 0.5 mm.

7. The data line according to claim 5, wherein the third surface abuts against the core wire assembly; and/or
an inner wall of the accommodation cavity has a fourth surface connected with the third surface, and the fourth surface is disposed perpendicular to the third surface.

8. The data line according to claim 7, wherein a diameter of the core wire assembly is the same as that of the second opening 1221, or the diameter of the core wire assembly is slightly larger than that of the second opening.

9. The data line according to claim 4, wherein the inner mold and the outer shell are connected by an adhesive, and an outer surface of the inner mold is provided with an overflow groove configured to accommodate the adhesive; and
the overflow groove comprises a first groove extending along a first direction and a second groove extending along a second direction, the first direction and the second direction intersect, and the first groove and the second groove are staggered.

10. The data line according to claim 9, wherein the first groove and the second groove enclose a protrusion, and a plurality of protrusions are formed.

11. The data line according to claim 10, wherein the protrusion is substantially cubic and has four surfaces intersecting the plugging direction.

12. The data line according to claim 4, wherein an inner wall of the outer shell is provided with an annular groove surrounding the plugging direction, and a surface of the inner mold facing the outer shell is provided with a rib, and the rib is in a limiting fit with the annular groove.

13. The data line according to claim 12, wherein the surface of the inner mold facing the outer shell is provided with a plurality of ribs arranged at intervals along a circumferential direction of the inner mold.

14. The data line according to claim 12, wherein the annular groove is same as the outer shell in shape.

15. The data line according to claim 14, wherein the outer shell and the annular groove each comprises a racetrack-shape, that prevents the inner mold from rotating around the plugging direction.

16. The data line according to claim 1, further comprising a stress relief sleeve disposed at an end of the core wire assembly.

17. A manufacturing method of a data line comprising a core wire assembly and a braided layer which encloses the core wire assembly, the braided layer having a plurality of braiding gaps, the manufacturing method comprises:
attaching a filling coating to the braided layer such that the filling layer filled in the plurality of braiding gaps, and the filling layer and the braided layer jointly enclose the core wire assembly; and
baking the data line attached with the filling coating.

18. The manufacturing method according to claim 17, wherein the filling coating comprises 25 to 35 parts by mass of methyvinylsiloxane, and/or 10 to 15 parts by mass of silicon dioxide, and/or 10 to 15 parts by mass of hydrosilicone oil, and/or 35 to 40 parts by mass of light white oil.

19. The manufacturing method according to claim 17, wherein baking the data line attached with the filling coating comprises:
baking the data line attached with the filling coating at a preset temperature for 2 to 3 hours to cure the filling coating.

20. The manufacturing method according to claim 19, wherein the preset temperature is between 180° C. to 220° C.
